(19) United States
(12) Patent Application Publication
(10) Pub. No.: US 2020/0019507 A1
(43) Pub. Date: Jan. 16, 2020

(54) CONTROLLER AND OPERATING METHOD THEREOF

(71) Applicant: SK hynix Inc., Gyeonggi-do (KR)

(72) Inventors: Young-Ick CHO, Seoul (KR); Byeong-Gyu PARK, Gyeonggi-do (KR); Sung-Kwan HONG, Seoul (KR)

(21) Appl. No.: 16/381,235

(22) Filed: Apr. 11, 2019

(30) Foreign Application Priority Data
Jul. 10, 2018 (KR) 10-2018-0080051

(51) Int. Cl. G06F 12/0873

(52) U.S. Cl. CPC G06F 12/0873; G06F 2212/608

(57) ABSTRACT

A controller includes a determination component suitable for determining whether target map data corresponding to a read request is compressible and a compression ratio for the target map data; a memory suitable for storing a meta table in which information on whether the target map data is compressible and the compression ratio for the target map data are contained, the memory comprising a map cache buffer including a retention area and a non-retention area; a compressor suitable for compressing the target map data at the determined compression ratio, when it is determined that the target map data is compressible; and a processor suitable for storing the compressed target map data in the retention area.

### CROSS-REFERENCE TO RELATED APPLICATION

The present application claims priority under 35 U.S.C. § 119(a) to Korean Patent Application No. 10-2018-0080051, filed on Jul. 10, 2018, the disclosure of which is incorporated herein by reference in its entirety.

### BACKGROUND

### 1. Field

Various embodiments of the present invention relate to a controller. Particularly, various embodiments relate to a controller capable of efficiently processing data stored in a map cache memory, and an operating method thereof.

### 2. Description of the Related Art

The computer environment paradigm has moved towards ubiquitous computing, which enables computing systems to be used anytime and anywhere. As a result, the demand for portable electronic devices, such as mobile phones, digital cameras, and laptop computers have increased rapidly. Those electronic devices generally include a memory system using a memory device as a data storage device. The data storage device may be used as a main memory or an auxiliary memory of a portable electronic device.

Since there is no mechanical driving part, a data storage device provides advantages such as excellent stability and durability, high information access speed, and low power consumption. Also, such data storage device can have a quick data access rate with low power consumption compared to a hard disk device. Non-limiting examples of the data storage device having such advantages include universal serial bus (USB) memory devices, memory cards of diverse interfaces, and solid state drives (SSDs).

### SUMMARY

Various embodiments of the present invention are directed to a controller capable of efficiently processing data stored in a map cache memory.

In accordance with an embodiment of the present invention, a controller may include: a determination component suitable for determining whether target map data corresponding to a read request is compressible and a compression ratio for the target map data; a memory suitable for storing a meta table in which information on whether the target map data is compressible and the compression ratio for the target map data are contained, the memory comprising a map cache buffer including a retention area and a non-retention area; a compressor suitable for compressing the target map data at the determined compression ratio, when it is determined that the target map data is compressible; and a processor suitable for storing the compressed target map data in the retention area.

In accordance with an embodiment of the present invention, an operating method of a controller may include: determining information on whether target map data corresponding to a read request is compressible and a compression ratio for the target map data; storing the information on whether the target map data is compressible and the compression ratio; compressing the target map data at the compression ratio, when it is determined that the target map data is compressible; and storing the compressed target map data in a retention area of a memory.

In accordance with an embodiment of the present invention, a memory system may include: a memory device suitable for storing target map data corresponding to a read request; and a controller suitable for loading the target map data from the memory device, storing the target map data in a memory including a retention area and a non-retention area, based on information on whether the target map data is compressible and a compression ratio for the target map data, compressing the target map data at the compression ratio when it is determined that the target map data is compressible, and storing the compressed target map data in the retention area.

In accordance with an embodiment of the present invention, a memory system may include: a memory device; and a controller including a memory, which includes a retention area and a non-retention area, wherein the controller is suitable for: controlling the memory device to store target map data corresponding to a read request; storing information for the target map data in the memory, the information indicating whether the target map data is compressible; loading the target map data from the memory device; determining whether the target map data is compressible based on the information; compressing the target map data when it is determined that the target map data is compressible; and storing the compressed target map data in the retention area.

### BRIEF DESCRIPTION OF THE DRAWINGS

The description herein makes reference to the accompanying drawings wherein like reference numerals refer to like parts throughout the several views, and wherein:

FIG. 1 is a block diagram illustrating a data processing system including a memory system in accordance with an embodiment of the present disclosure;

FIG. 2 is a schematic diagram illustrating a memory device of a memory system in accordance with an embodiment of the present disclosure;

FIG. 3 is a circuit diagram illustrating a memory cell array of a memory block in a memory device in accordance with an embodiment of the present disclosure;

FIG. 4 is a schematic diagram illustrating a three-dimensional structure of a memory device in accordance with an embodiment of the present disclosure;

FIG. 5 illustrates the structure of a memory system in accordance with an embodiment of the present disclosure;

FIG. 6 illustrates the structure of a memory in accordance with an embodiment of the present disclosure;

FIG. 7 illustrates a meta table in accordance with an embodiment of the present disclosure;

FIG. 8 is a flowchart illustrating an operation of a controller in accordance with an embodiment of the present disclosure;

FIG. 9 is a flowchart illustrating an operation of a controller in accordance with an embodiment of the present disclosure; and

FIGS. 10 to 18 are schematic diagrams illustrating exemplary applications of a data processing system, in accordance with various embodiments of the present invention.

### DETAILED DESCRIPTION

Various embodiments of the disclosure are described below in more detail with reference to the accompanying drawings. However, elements and features of the present invention may be configured or arranged to form other embodiments, which may be modifications or variations of any of the disclosed embodiments. Thus, the present invention is not limited to the embodiments set forth herein. Rather, the described embodiments are provided so that this disclosure is thorough and complete and fully conveys the present invention to those skilled in the art to which this invention pertains. Throughout the disclosure, like reference numerals refer to like parts throughout the various figures and examples of the disclosure. It is noted that reference to “an embodiment” or the like does not necessarily mean only one embodiment, and different references to any such phrase are not necessarily to the same embodiment(s).

It will be understood that, although the terms “first”, “second”, “third”, and so on may be used herein to identify various elements, these elements are not limited by these terms. These terms are used to distinguish one element from another element that otherwise have the same or similar names. Thus, a first element in one instance may be termed a second or third element in another instance without departing from the spirit and scope of the present invention.

The drawings are not necessarily to scale and, in some instances, proportions may have been exaggerated in order to clearly illustrate features of the embodiments.

It will be further understood that when an element is referred to as being “connected to”, or “coupled to” another element, it may be directly on, connected to, or coupled to the other element, or one or more intervening elements may be present. In addition, it will also be understood that when an element is referred to as being “between” two elements, it may be the only element between the two elements, or one or more intervening elements may also be present. Whether two elements are directly or indirectly connected/coupled, communication between the two elements may be wired or wireless, unless stated or the context indicates otherwise.

The terminology used herein is for the purpose of describing particular embodiments and is not intended to be limiting of the present invention.

As used herein, singular forms are intended to include the plural forms and vice versa, unless the context clearly indicates otherwise.

It will be further understood that the terms “comprises,” “comprising,” “includes,” and “including” when used in this specification, specify the presence of the stated elements and do not preclude the presence or addition of one or more other elements. As used herein, the term “and/or” includes any and all combinations of one or more of the associated listed items.

Unless otherwise defined, all terms including technical and scientific terms used herein have the same meaning as commonly understood by one of ordinary skill in the art to which the present invention belongs in view of the present disclosure. It will be further understood that terms, such as those defined in commonly used dictionaries, should be interpreted as having a meaning that is consistent with their meaning in the context of the present disclosure and the relevant art and not be interpreted in an idealized or overly formal sense unless expressly so defined herein.

In the following description, numerous specific details are set forth in order to provide a thorough understanding of the present invention. The present invention may be practiced without some or all of these specific details. In other instances, well-known process structures and/or processes have not been described in detail in order not to unnecessarily obscure the present invention.

It is also noted, that in some instances, as would be apparent to those skilled in the relevant art, a feature or element described in connection with one embodiment may be used singly or in combination with other features or elements of another embodiment, unless otherwise specifically indicated.

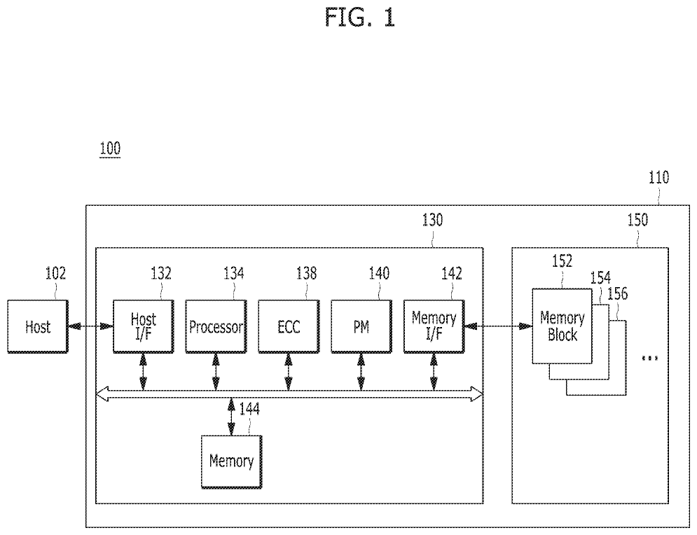

FIG. 1 is a block diagram illustrating a data processing system 100 in accordance with an embodiment of the present invention.

Referring to FIG. 1, the data processing system 100 may include a host 102 operatively coupled to a memory system 110.

The host 102 may include, for example, any of a variety of portable electronic devices such as a mobile phone, an MP3 player and a laptop computer or an electronic device such as a desktop computer, a game player, a television (TV), a projector, and the like.

The memory system 110 may operate or perform a specific function or operation in response to a request from the host 102 and, particularly, may store data to be accessed by the host 102. The memory system 110 may be used as a main memory system or an auxiliary memory system of the host 102. The memory system 110 may be implemented with any one of various types of storage devices, which may be electrically coupled with the host 102, according to a protocol of a host interface. Non-limiting examples of suitable storage devices include a solid state drive (SSD), a multimedia card (MMC), an embedded MMC (eMMC), a reduced size MMC (RS-MMC) and a micro-MMC, a secure digital (SD) card, a mini-SD and a micro-SD, a universal serial bus (USB) storage device, a universal flash storage (UFS) device, a compact flash (CF) card, a smart media (SM) card, a memory stick, and the like.

The storage devices for the memory system 110 may be implemented with a volatile memory device such as a dynamic random access memory (DRAM) and/or a static RAM (SRAM), and/or a nonvolatile memory device such as a read only memory (ROM), a mask ROM (MROM), a programmable ROM (PROM), an erasable programmable ROM (EPROM), an electrically erasable programmable ROM (EEPROM), a ferroelectric RAM (FRAM), a phase-change RAM (PRAM), a magneto-resistive RAM (MRAM), a resistive RAM (RRAM or ReRAM), and/or a flash memory.

The memory system 110 may include a controller 130 and a memory device 150. The memory device 150 may store data to be accessed by the host 102, and the controller 130 may control storage of data in the memory device 150.

The controller 130 and the memory device 150 may be integrated into a single semiconductor device, which may be included in any of the various types of memory systems as exemplified above.

The memory system 110 may be configured as a part of, for example, a computer, an ultra-mobile PC (UMPC), a workstation, a net-book, a personal digital assistant (PDA), a portable computer, a web tablet, a tablet computer, a wireless phone, a mobile phone, a smart phone, an e-book, a portable multimedia player (PMP), a portable game player, a navigation system, a black box, a digital camera, a digital multimedia broadcasting (DMB) player, a 3-dimensional (3D) television, a smart television, a digital audio recorder, a digital audio player, a digital picture recorder, a digital picture player, a digital video recorder, a digital video player, a storage configuring a data center, a device capable of transmitting and receiving information under a wireless environment, one of various electronic devices configuring a home network, one of various electronic devices configuring a computer network, one of various electronic devices configuring a telematics network, a radio frequency identification (RFID) device, or one of various components configuring a computing system.

The memory device 150 may be a nonvolatile memory device that retains data stored therein even while an electrical power is not supplied. The memory device 150 may store data provided from the host 102 through a write operation, and provide data stored therein to the host 102 through a read operation. The memory device 150 may include a plurality of memory blocks 152 to 156, each of which may include a plurality of pages. Each of the plurality of pages may include a plurality of memory cells to which a plurality of word lines (WL) are electrically coupled.

The controller 130 may control overall operations of the memory device 150, such as read, write, program and erase operations. For example, the controller 130 may control the memory device 150 in response to a request from the host 102. The controller 130 may provide the data, read from the memory device 150, to the host 102, and/or may store the data, provided by the host 102, into the memory device 150.

The controller 130 may include a host interface (I/F) 132, a processor 134, an error correction code (ECC) component 138, a power manager (PM) 140, a memory interface (I/F) 142, and a memory 144, all operatively coupled via an internal bus.

The host interface 132 may process commands and data provided from the host 102, and may communicate with the host 102 through at least one of various interface protocols such as universal serial bus (USB), multimedia card (MMC), peripheral component interconnect-express (PCI-e or PCIe), small computer system interface (SCSI), serial-attached SCSI (SAS), serial advanced technology attachment (SATA), parallel advanced technology attachment (PATA), small computer system interface (SCSI), enhanced small disk interface (ESDI), and integrated drive electronics (IDE).

The ECC component 138 may detect and correct errors in the data read from the memory device 150 during the read operation. When the number of the error bits is greater than or equal to a threshold number of correctable error bits, the ECC component 138 may not correct error bits but instead may output an error correction fail signal indicating failure in correcting the error bits.

The ECC component 138 may perform an error correction operation based on a coded modulation such as a low density parity check (LDPC) code, a Bose-Chaudhuri-Hocquenghem (BCH) code, a turbo code, a Reed-Solomon (RS) code, a convolution code, a recursive systematic code (RSC), a trellis-coded modulation (TCM), a Block coded modulation (BCM), and the like. The ECC component 138 may include all or some of circuits, modules, systems or devices for performing the error correction operation based on at least one of the above described codes.

The PM 140 may provide and manage power of the controller 130.

The memory interface 142 may serve as an interface for handling commands and data, transferred between the controller 130 and the memory device 150, to allow the controller 130 to control the memory device 150 in response to a request delivered from the host 102. The memory interface 142 may generate a control signal for the memory device 150 and may process data entered into or outputted from the memory device 150 under the control of the processor 134, when the memory device 150 is a flash memory and, in particular, a NAND flash memory.

The memory 144 may serve as a working memory of the memory system 110 and the controller 130, and may store temporary or transactional data for operating or driving the memory system 110 and the controller 130. The controller 130 may control the memory device 150 in response to a request from the host 102. The controller 130 may deliver data read from the memory device 150 into the host 102, may store data entered through the host 102 within the memory device 150. The memory 144 may be used to store data required for the controller 130 and the memory device 150 in order to perform these operations.

The memory 144 may be implemented with a volatile memory. The memory 144 may be implemented with a static random access memory (SRAM) or a dynamic random access memory (DRAM). Although FIG. 1 shows the memory 144 disposed within the controller 130, the disclosure is not limited thereto. That is, the memory 144 may be located within or externally to the controller 130. For instance, the memory 144 may be embodied by an external volatile memory having a memory interface transferring data and/or signals between the memory 144 and the controller 130.

The processor 134 may control the overall operations of the memory system 110. The processor 134 may drive or execute a firmware to control the overall operations of the memory system 110. The firmware may be referred to as a flash translation layer (FTL).

An FTL may perform an operation as an interface between the host 102 and the memory device 150. The host 102 may transmit requests for write and read operations to the memory device 150 through the FTL.

The FTL may manage operations of address mapping, garbage collection, wear-leveling and the like. Particularly, the FTL may store map data. Therefore, the controller 130 may map a logical address, which is provided from the host 102, to a physical address of the memory device 150 through the map data. The memory device 150 may perform an operation like a general device because of the address mapping operation. Also, through the address mapping operation based on the map data, when the controller 130 updates data of a particular page, the controller 130 may program new data on another empty page and may invalidate old data of the particular page due to a characteristic of a flash memory device. Further, the controller 130 may store map data of the new data into the FTL.

The processor 134 may be implemented with a microprocessor or a central processing unit (CPU). The memory system 110 may include one or more processors 134.

A management unit (not shown) may be included in the processor 134. The management unit may perform bad block management of the memory device 150. The management unit may find bad memory blocks in the memory device 150, which are in unsatisfactory condition for further use, as well as perform bad block management on the bad memory blocks. When the memory device 150 is a flash memory, for example, a NAND flash memory, a program failure may occur during the write operation, for example, during the program operation, due to characteristics of a NAND logic function. During the bad block management, the data of the program-failed memory block or the bad memory block may be programmed into a new memory block. The bad blocks may significantly reduce the utilization efficiency of the memory device 150 having a 3D stack structure and the reliability of the memory system 100, and thus reliable bad block management is required.

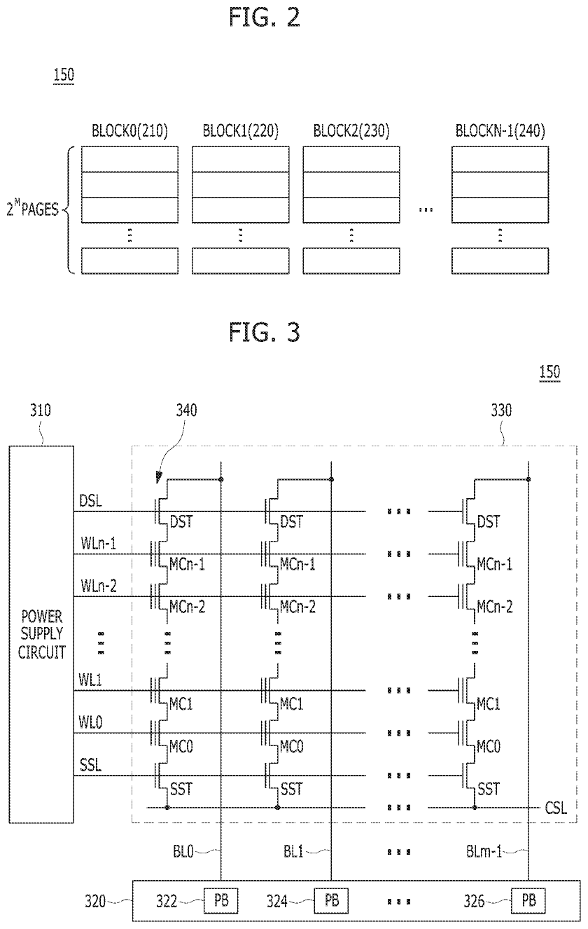

FIG. 2 is a schematic diagram illustrating a memory device, e.g., the memory device 150 of FIG. 1, in accordance with an embodiment of the present disclosure.

Referring to FIG. 2, the memory device 150 may include the plurality of memory blocks BLOCK0 210 to BLOCKN−1 240, and each of the blocks BLOCK0 210 to BLOCKN−1 240 may include a plurality of pages, for example, 2^{M} pages, the number of which may vary according to circuit design. The memory device 150 may include a plurality of memory blocks, as single level cell (SLC) memory blocks and multi-level cell (MLC) memory blocks, according to the number of bits which may be stored or expressed in each memory cell. The SLC memory block may include a plurality of pages which are implemented with memory cells each capable of storing 1-bit data. The MLC memory block may include a plurality of pages which are implemented with memory cells each capable of storing multi-bit data, for example, two or more-bit data. An MLC memory block including a plurality of pages which are implemented with memory cells that are each capable of storing 3-bit data may be defined as a triple level cell (TLC) memory block.

FIG. 3 is a circuit diagram illustrating a memory block 330 in the memory device 150 in accordance with an embodiment of the present disclosure.

Referring to FIG. 3, the memory block 330 may correspond to any of the plurality of memory blocks 152 to 156 in the memory device 150 of the memory system 110.

The memory block 330 may include a plurality of cell strings 340 which are electrically coupled to bit lines BL0 to BLm−1, respectively. The cell string 340 of each column may include at least one drain select transistor DST and at least one source select transistor SST. A plurality of memory cells or a plurality of memory cell transistors MC0 to MCn−1 may be electrically coupled in series between the select transistors DST and SST. The respective memory cells MC0 to MCn−1 may be configured as single level cells (SLC) each of which may store 1 bit of information, or as multi-level cells (MLC) each of which may store a plurality of bits. The strings 340 may be electrically coupled to the corresponding bit lines BL0 to BLm−1, respectively. For reference, in FIG. 3, ‘DSL’ denotes a drain select line, ‘SSL’ denotes a source select line, and ‘CSL’ denotes a common source line.

While FIG. 3 shows, as an example, that the memory block 330 is constituted with NAND flash memory cells, it is to be noted that the memory block 330 of the memory device 150 is not limited to a NAND flash memory. The memory block 330 may be configured for a NOR flash memory, a hybrid flash memory in which at least two kinds of memory cells are combined, or one-NAND flash memory in which a controller is built in a memory chip. The operational characteristics of a semiconductor device may be applied to not only a flash memory device in which a charge storing layer is configured by conductive floating gates but also a charge trap flash (CTF) in which a charge storing layer is configured by a dielectric layer.

A power supply circuit 310 of the memory device 150 may supply word line voltages, for example, a program voltage, a read voltage and a pass voltage, to respective word lines according to an operation mode, as well as supply voltages to bulks, for example, well regions in which the memory cells are formed. The power supply circuit 310 may perform a voltage generating operation under the control of a control circuit (not shown). The power supply circuit 310 may generate a plurality of variable read voltages to generate a plurality of read data, select one of the memory blocks or sectors of a memory cell array under the control of the control circuit, select one of the word lines of the selected memory block, and provide the word line voltages to the selected word line and unselected word lines.

A read and write (read/write) circuit 320 of the memory device 150 may be controlled by the control circuit, and may serve as a sense amplifier or a write driver according to an operation mode. During a verification operation or a normal read operation, the read/write circuit 320 may operate as a sense amplifier for reading data from the memory cell array. During a program operation, the read/write circuit 320 may operate as a write driver for driving bit lines according to data to be stored in the memory cell array. During a program operation, the read/write circuit 320 may receive from a buffer (not illustrated) data to be stored into the memory cell array, and drive bit lines according to the received data. The read/write circuit 320 may include a plurality of page buffers 322 to 326 respectively corresponding to columns (or bit lines) or column pairs (or bit line pairs), and each of the page buffers 322 to 326 may include a plurality of latches (not illustrated).

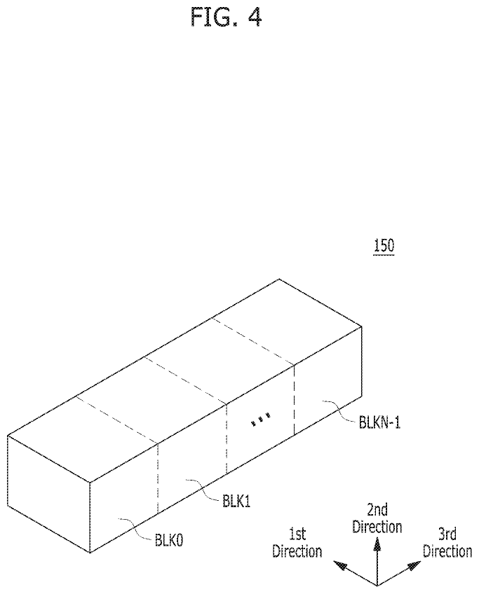

FIG. 4 is a schematic diagram illustrating a three-dimensional (3D) structure of a memory device, e.g., the memory device 150, in accordance with an embodiment of the present disclosure.

Specifically, as illustrated in FIG. 4, the memory device 150 may be embodied in a nonvolatile memory device having a 3D stack structure. When the memory device 150 has a 3D structure, the memory device 150 may include a plurality of memory blocks BLK0 to BLKN−1 each having a 3D structure (or a vertical structure). As an alternative to the 3D structure shown in FIG. 3, the memory device 150 may be configured as a two-dimensional (2D) structure.

Regarding the workloads of portable electronic devices, a memory system used in each of the portable electronic devices can reduce its power consumption through hibernation. In this case, as the memory system is switched from a normal mode to a sleep mode, the power consumption of the memory system can be reduced. However, while the memory system transitions or changes from the sleep mode to the normal mode again, some of existing data stored in the memory system may be lost.

In particular, while the memory system changes to the sleep mode or the normal mode according to hibernation, map data which serve as a considerably important element in FTL operation may be lost from a memory of a controller. Therefore, during a read operation, the map data need to be reloaded to the memory of the controller from a memory device. As a result, the read performance of the memory system may be degraded.

In order to prevent the above-described degradation, the memory system 110 provides a method capable of preventing data loss using a retention area included in the memory 144 of the controller 130, even while the memory system 110 changes from the sleep mode to the normal mode.

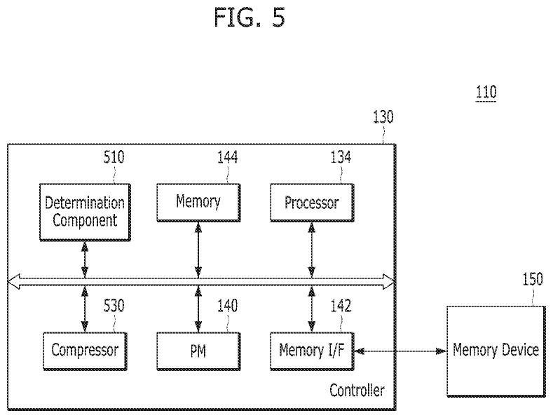

FIG. 5 illustrates the structure of a memory system, e.g., the memory system 110 of FIG. 1, in accordance with the present embodiment. For clarity and to facilitate the following description, FIG. 5 illustrates only some components of the memory system 110 illustrated in FIG. 1.

The memory system 110 may include the controller 130 and the memory device 150. As described above, the controller 130 may control the memory device 150 described with reference to FIGS. 2 to 4.

The controller 130 may further include a determination component 510 and a compressor 530 in addition to the power manager (PM) 140, the memory 144, the memory interface (I/F) 142 and the processor 134.

As described with reference to FIG. 1, the PM 140 may manage the overall power of the memory system 110. For example, when the memory system 110 enters the sleep mode, the PM 140 may supply power to some components, and not supply or cut off power to other components. Furthermore, the PM 140 may frequently check residual power which can be provided to the memory system 110 at the moment.

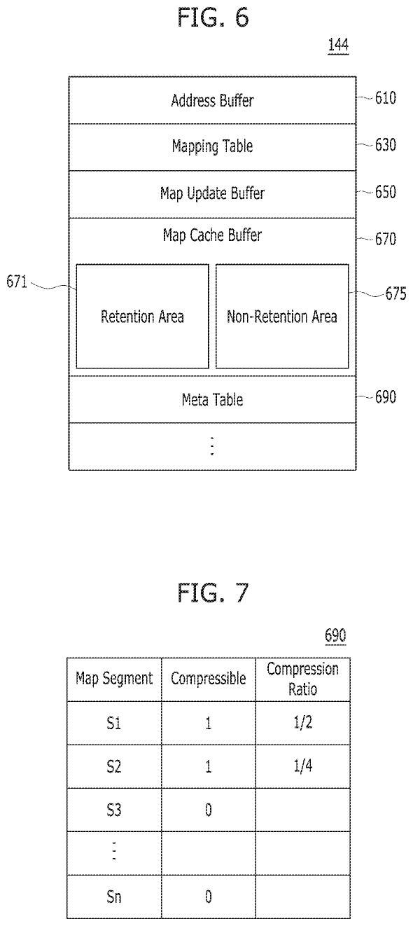

FIG. 6 illustrates the structure of the memory 144 in accordance with an embodiment. For clarity, FIG. 6 illustrates components of the memory 144 pertinent to the present embodiment.

Referring to FIG. 6, the memory 144 may include an address buffer 610, a mapping table 630, a map update buffer 650, a map cache buffer 670 and a meta table 690. The memory 144 may store a logical block address corresponding to data provided from the host 102 and a physical block address indicating a location where data corresponding to a request provided from the host 102 are actually stored in the memory device 150, using the plurality of buffers and tables. Furthermore, the memory 144 may store mapping information indicating the mapping relationship between the logical block address and the physical block address. Hereafter, the mapping information may be referred to as map data. The memory 144 may manage the map data in a map segment basis.

The address buffer 610 may store map data. Specifically, the address buffer 610 may store mapping information indicating the mapping relationship between a logical block address LBA of target data corresponding to a write request provided from the host 102 and a physical block address PBA of the memory device 150, in which the target data are to be actually stored.

The mapping table 630 may record map data stored in the address buffer 610. The mapping table 630 may include a plurality of map segments. Each of the map segments may include a plurality of map data. The mapping table 630 may be updated. For example, the map data stored in the mapping table 630 may be updated whenever the sum of the sizes of target data corresponding to write requests from the host 102 becomes a set size, which may be predetermined, or updated whenever the address buffer 610 has no empty space. However, this is only an example; the time at which the map data stored in the mapping table 630 is updated is not specifically limited.

The map update buffer 650 may temporarily store map data which are to be updated, among the map data stored in the memory device 150. A physical block address PBA for each of the map data which are temporarily stored in the map update buffer 650 may be changed to correspond to the map data stored in the address buffer 610. As the map data of which the physical block address PBA has been changed is stored in the memory device 150 according to control of the processor 134, the update of the mapping table 630 may be completed.

The map cache buffer 670 may cache map data corresponding to a logical block address corresponding to a read request which has been recently provided from the host 102 or a logical block address corresponding to a read request which is frequently provided from the host 102. The cached map data may be compressed or not.

The map cache buffer 670 may include a retention area 671 and a non-retention area 675. Although the memory system 110 enters the sleep mode, power may be supplied to the retention area 671. Therefore, map data stored in the retention area 671 may not be lost even in the sleep mode. On the other hand, power supplied to the non-retention area 675 may be cut off when the memory system 110 enters the sleep mode. Therefore, map data stored in the non-retention area 675 may be lost in the sleep mode.

The map cache buffer 670 may store compressed map data in the retention area 671, and store uncompressed map data in the non-retention area 675. Furthermore, the map cache buffer 670 may even store compressed map data in the non-retention area 675, based on the current residual power of the memory system 110.

The meta table 690 may store information on whether each of the map data can be compressed and the compression ratio of the map data. Furthermore, the meta table 690 may store information on whether each of the map segments can be compressed and the compression ratio of the map segment. The meta table 690 may include a bitmap table.

FIG. 7 illustrates a meta table, e.g., the meta table 690 of FIG. 6, in accordance with the present embodiment. Referring to FIG. 7, the meta table 690 may have three fields which are represented by ‘map segment’, ‘compressible’ and ‘compression ratio’, and correspond to a plurality of map segments, information on whether the map segments can be compressed, and compression ratios, respectively. In the meta table 690, the information on whether each of the map segments can be compressed may be expressed as a logic high level, e.g., ‘1’ or a logic low level, e.g., ‘0’. For example, in the meta table 690, a compressible map segment may be expressed as ‘1’, and an incompressible map segment may be expressed as ‘0’.

For example, a first map segment S1 can be compressed to ½ of its original size. That is, the first map segment S1 can be compressed to 50% of the original size according to a compression ratio of 50%. For another example, a second map segment S2 can be compressed to ¼ or 25% of the original size according to a compression ratio of 75%. However, a third map segment S3 cannot be compressed. This configuration is only an example; the present invention is not limited thereto.

Referring back to FIG. 5, the processor 134 may store the map data stored in the memory 144 into the memory device 150 through the memory interface 142. For example, when the map data stored in the memory 144 are updated, the processor 134 may store the updated map data in the memory device 150. On the other hand, the processor 134 may store the map data stored in the memory device 150 into the memory 144 through the memory interface 142. For example, when target map data corresponding to a read request provided from the host 102 is not retrieved from the memory 144, the processor 134 may load the target map data from the memory device 150, and store the loaded target map data in the memory 144.

The processor 134 may divide and store the map data loaded from the memory device 150 into the retention area 671 and the non-retention area 675, which are will be described below. For example, the processor 134 may store compressed map data in the retention area 671, and store uncompressed map data in the non-retention area 675.

The processor 134 may receive information on the residual power of the memory system 110 from the PM 140, and set a threshold value corresponding to the residual power. The threshold value may be predetermined. Specifically, when the residual power is low, the processor 134 may set the threshold value to a relatively large value. On the other hand, when the residual power is high, the processor 134 may set the threshold value to a relatively small value. The processor 134 may compare the compression ratio of map data to the threshold value corresponding to the residual power. The processor 134 may store the map data in the retention area 671 or the non-retention area 675 according to the comparison result. For example, when the residual power corresponds to 50% of the entire power, the processor 134 may set the threshold value to 50, and store map data having a compression ratio of 50% or more in the retention area 671. For another example, when the residual power corresponds to 20% of the entire power, the processor 134 may set the threshold value to 80, and store map data having a compression ratio of 80% or more in the retention area 671.

The determination component 510 may determine whether each of the map data stored in the memory 144 can be compressed and the compression ratio of the map data. The determination component 510 may determine whether the map data can be compressed and the compression ratio of the map data, on a map segment basis. Furthermore, the determination component 510 may determine whether the map data can be compressed and the compression ratio of the map data, at the point of time when the map data is updated. For example, when a map update result indicates that sequential map data are present among map data included in a map segment, the determination component 510 may determine that the corresponding map segment can be compressed. Furthermore, the determination component 510 may determine a compression ratio based on the ratio of the sequential map data. For example, the determination component 510 may set the compression ratio for the map segment to one of ½, ¼ and ⅛. However, this is only an example; the present invention is not limited thereto. The determination component 510 may provide the memory 144 with the determined information on whether the map data can be compressed and the determined compression ratio.

The compressor 530 may compress the map data based on the determined information on whether the map data can be compressed and the determined compression ratio. The compressor 530 may provide the compressed map data to the memory 144 according to control of the processor 134.

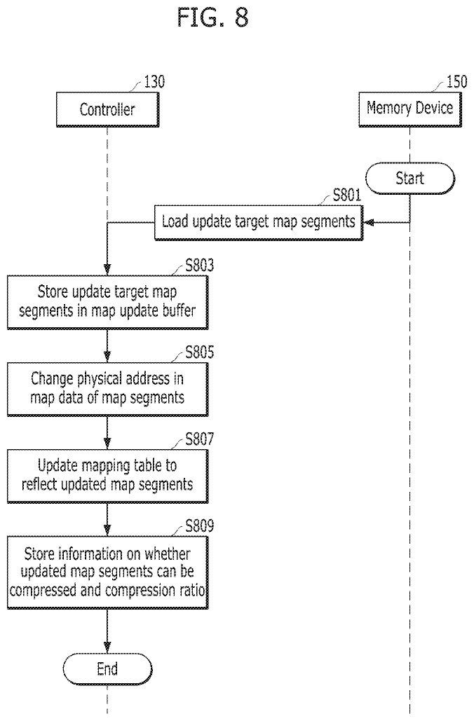

FIG. 8 is a flowchart illustrating an operation of a controller, e.g., the controller 130 of FIG. 5, in accordance with an embodiment. In particular, FIG. 8 illustrates an operation of the controller 130 that determines whether each of map data may be compressed and the compression ratio of the map data, according to a map update operation. In the context of the present description, the map update operation is performed on a map segment basis. This, however, is merely an example, as the map update operation may be performed on other bases.

Referring to FIG. 8, at step S801, the processor 134 may load map segments corresponding to an update target among map segments stored in the memory device 150. For example, the processor 134 may load, from the memory device 150, map segments corresponding to data which are newly stored in the memory device 150 or map segments including map data of which the previously stored physical addresses have been changed.

At step S803, the memory 144 may temporarily store the map segments corresponding to the update target in the map update buffer 650 according to control of the processor 134.

At step S805, the memory 144 may update the physical addresses of map data in each of the map segments stored in the map update buffer 650.

At step S807, the memory 144 may update the mapping table 630 to reflect the updated map segments into the mapping table 630.

At step S809, the determination component 510 may determine whether each of the updated map segments can be compressed and the compression ratio of the map segment, and provide the memory 144 with the determined information on whether each of the updated map segments can be compressed and the determined compression ratio. The memory 144 may update the meta table 690 to reflect the information on whether each of the updated map segments can be compressed and the compression ratio.

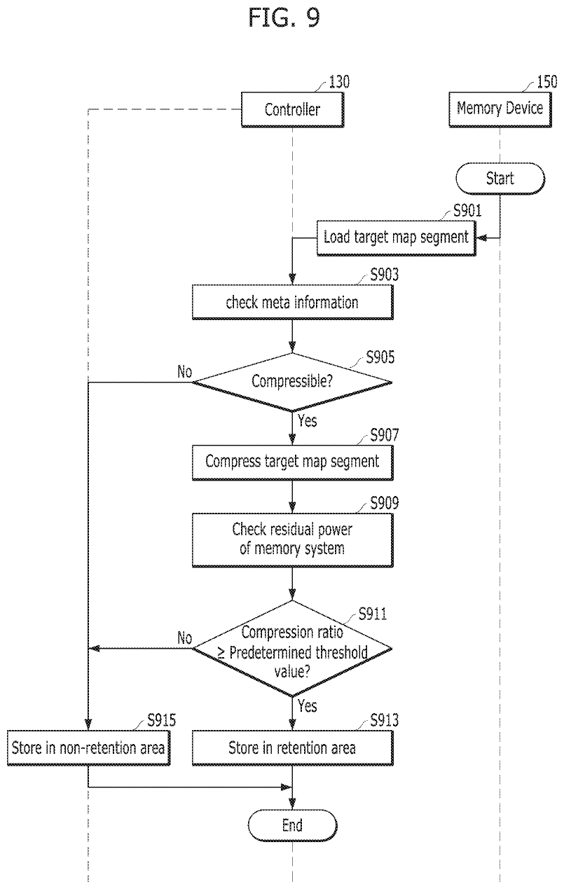

FIG. 9 is a flowchart illustrating an operation of a controller, e.g., the controller 130, in accordance with an embodiment. For example, FIG. 9 illustrates an operation of the controller 130 to load map data from the memory device 150. Here, an example is described in which map data corresponding to a read request provided from the host 102 are not stored in the memory 144. That is, the controller 130 needs to load the map data corresponding to the read request and stored in the memory device 150, in order to read data corresponding to the read request. As an example, the map data are loaded on a map segment basis.

Referring to FIG. 9, at step S901, the processor 134 may load a target map segment from the memory device 150. The target map segment may correspond to a read request provided from the host 102.

At step S903, the processor 134 may check meta information corresponding to the target map segment, based on the meta table 690 within the memory 144. The meta information may include information on whether the target map segment can be compressed and the compression ratio of the target map segment.

When the target map segment cannot be compressed (No at step S905), the processor 134 may store the target map segment in the non-retention area 675 within the map cache buffer 670 at step S915.

On the other hand, when the target map segment can be compressed (Yes at step S905), the compressor 530 may compress the target map segment at a compression ratio, which may be predetermined, according to control of the processor 134, at step S907.

At step S909, the PM 140 may check the residual power of the memory system 110. The PM 140 may provide information on the residual power to the processor 134. The operation of checking residual power is not limited to this particular point in the process. The PM 140 may frequently check the residual power of the memory system 110.

At step S911, the processor 134 may compare the compression ratio of the target map segment to a threshold value corresponding to the residual power.

When the compression ratio is less than the threshold value (No at step S911), the processor 134 may store the compressed target map segment in the non-retention area 675 within the map cache buffer 670 at step S915.

On the other hand, when the compression ratio is greater than or equal to the threshold value (Yes at step S911), the processor 134 may store the compressed target map segment in the retention area 671 within the map cache buffer 670 at step S913.

When the map data are divided and stored in the retention area 671 and the non-retention area 675, a relatively large amount of map data may be stored in the memory 144 in which the map data may be restrictively stored due to the power efficiency of the memory system 110. Furthermore, although the memory system 110 enters the sleep mode, a relatively large amount of map data may not be lost, but retained in the memory 144.

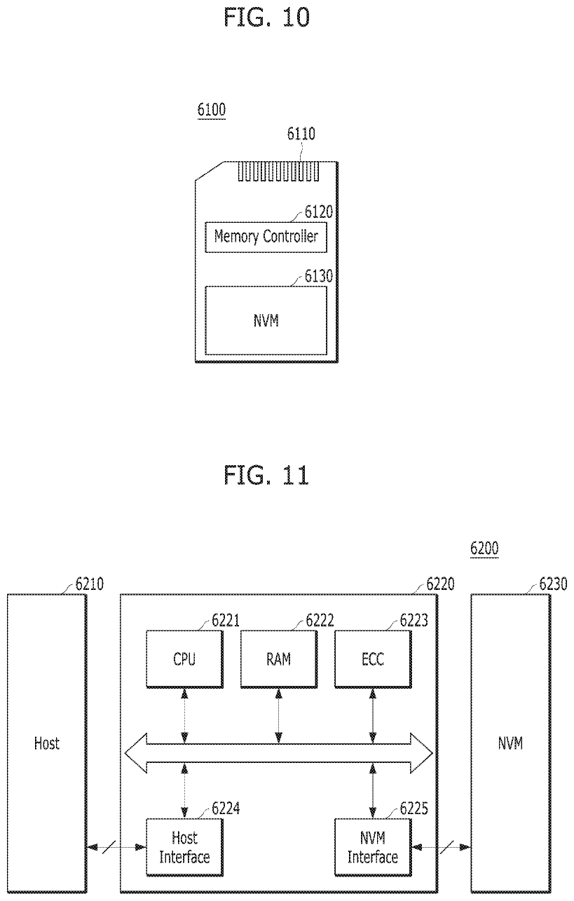

A data processing system and electronic devices which may be constituted with the memory system 110 including the memory device 150 and the controller 130, which are described above by referring to FIGS. 1 to 9, are described in detail below with reference to FIGS. 10 to 18.

FIGS. 10 to 18 are diagrams schematically illustrating exemplary applications of the data processing system of FIGS. 1 to 9 in accordance with various embodiments.

FIG. 10 is a diagram schematically illustrating an example of the data processing system including the memory system in accordance with an embodiment. FIG. 10 schematically illustrates a memory card system 6100 to which the memory system may be applied.

Referring to FIG. 10, the memory card system 6100 may include a memory controller 6120, a memory device 6130 and a connector 6110.

More specifically, the memory controller 6120 may be connected to the memory device 6130, and may be configured to access the memory device 6130. The memory device 6130 may be embodied by a nonvolatile memory (NVM). By the way of example but not limitation, the memory controller 6120 may be configured to control read, write, erase and background operations on the memory device 6130. The memory controller 6120 may be configured to provide an interface between the memory device 6130 and a host (not shown) and/or drive firmware for controlling the memory device 6130. That is, the memory controller 6120 may correspond to the controller 130 in the memory system 110 described with reference to FIGS. 1 to 9, while the memory device 6130 may correspond to the memory device 150 described with reference to FIGS. 1 to 9.

Thus, as shown in FIG. 1, the memory controller 6120 may include a random access memory (RAM), a processor, a host interface, a memory interface and an error correction component. The memory controller 130 may further include the elements described in FIG. 1.

The memory controller 6120 may communicate with an external device, for example, the host 102 of FIG. 1 through the connector 6110. For example, as described with reference to FIG. 1, the memory controller 6120 may be configured to communicate with an external device through one or more of various communication protocols such as universal serial bus (USB), multimedia card (MMC), embedded MMC (eMMC), peripheral component interconnection (PCI), PCI express (PCIe), Advanced Technology Attachment (ATA), Serial-ATA, Parallel-ATA, small computer system interface (SCSI), enhanced small disk interface (EDSI), Integrated Drive Electronics (IDE), Firewire, universal flash storage (UFS), wireless fidelity (Wi-Fi or WiFi), and Bluetooth. Thus, the memory system and the data processing system may be applied to wired and/or wireless electronic devices, particularly mobile electronic devices.

The memory device 6130 may be implemented by a nonvolatile memory. For example, the memory device 6130 may be implemented by any of various nonvolatile memory devices such as an erasable and programmable ROM (EPROM), an electrically erasable and programmable ROM (EEPROM), a NAND flash memory, a NOR flash memory, a phase-change RAM (PRAM), a resistive RAM (ReRAM), a ferroelectric RAM (FRAM), and a spin torque transfer magnetic RAM (STT-RAM). The memory device 6130 may include a plurality of dies as in the memory device 150 of FIG. 1.

The memory controller 6120 and the memory device 6130 may be integrated into a single semiconductor device. For example, the memory controller 6120 and the memory device 6130 may be so integrated to form a solid state drive (SSD). Also, the memory controller 6120 and the memory device 6130 may be so integrated to form a memory card such as a PC card (e.g., Personal Computer Memory Card International Association (PCMCIA)), a compact flash (CF) card, a smart media card (e.g., SM and SMC), a memory stick, a multimedia card (e.g., MMC, RS-MMC, MMCmicro and eMMC), a secured digital (SD) card (e.g., SD, miniSD, microSD and SDHC), and/or a universal flash storage (UFS).

FIG. 11 is a diagram schematically illustrating another example of a data processing system 6200, including a memory system, in accordance with an embodiment.

Referring to FIG. 11, the data processing system 6200 may include a memory device 6230 having one or more nonvolatile memories (NVMs) and a memory controller 6220 for controlling the memory device 6230. The data processing system 6200 may serve as a storage medium such as a memory card (e.g., CF, SD, micro-SD or the like) or USB device, as described with reference to FIG. 1. The memory device 6230 may correspond to the memory device 150 in the memory system 110 described in FIGS. 1 to 9, and the memory controller 6220 may correspond to the controller 130 in the memory system 110 described in FIGS. 1 to 9.

The memory controller 6220 may control a read, write, or erase operation on the memory device 6230 in response to a request of the host 6210, and the memory controller 6220 may include one or more central processing units (CPUs) 6221, a buffer memory such as a random access memory (RAM) 6222, an error correction code (ECC) circuit 6223, a host interface 6224 and a memory interface such as an NVM interface 6225.

The CPU 6221 may control the operations on the memory device 6230, for example, read, write, file system management and bad page management operations. The RAM 6222 may be operated according to control of the CPU 6221, and used as a work memory, buffer memory or cache memory. When the RAM 6222 is used as a work memory, data processed by the CPU 6221 may be temporarily stored in the RAM 6222. When the RAM 6222 is used as a buffer memory, the RAM 6222 may be used for buffering data transmitted to the memory device 6230 from the host 6210 or transmitted to the host 6210 from the memory device 6230. When the RAM 6222 is used as a cache memory, the RAM 6222 may assist the memory device 6230 to operate at high speed.

The ECC circuit 6223 may correspond to the ECC component 138 of the controller 130 illustrated in FIG. 1. As described with reference to FIG. 1, the ECC circuit 6223 may generate an error correction code (ECC) for correcting a fail bit or error bit of data provided from the memory device 6230. The ECC circuit 6223 may perform error correction encoding on data provided to the memory device 6230, thereby forming data with a parity bit. The parity bit may be stored in the memory device 6230. The ECC circuit 6223 may perform error correction decoding on data outputted from the memory device 6230. In this case, the ECC circuit 6223 may correct an error using the parity bit. For example, as described with reference to FIG. 1, the ECC circuit 6223 may correct an error using Low Density Parity Check (LDPC) code, Bose-Chaudhri-Hocquenghem (BCH) code, turbo code, Reed-Solomon code, convolution code, Recursive Systematic Code (RSC) or coded modulation such as Trellis-Coded Modulation (TCM) or Block coded modulation (BCM).

The memory controller 6220 may transmit to, and/or receive from, the host 6210 data or signals through the host interface 6224, and may transmit to, and/or receive from, the memory device 6230 data or signals through the NVM interface 6225. The host interface 6224 may be connected to the host 6210 through a parallel advanced technology attachment (PATA) bus, a serial advanced technology attachment (SATA) bus, a small computer system interface (SCSI), a universal serial bus (USB), a peripheral component interconnect-express (PCIe), or a NAND interface. The memory controller 6220 may have a wireless communication function with a mobile communication protocol such as wireless fidelity (WiFi) or Long Term Evolution (LTE). The memory controller 6220 may be connected to an external device, e.g., the host 6210, or another external device, and then transmit and/or receive data to and/or from the external device. As the memory controller 6220 is configured to communicate with the external device through one or more of various communication protocols, the memory system and the data processing system may be applied to wired and/or wireless electronic devices, particularly a mobile electronic device.

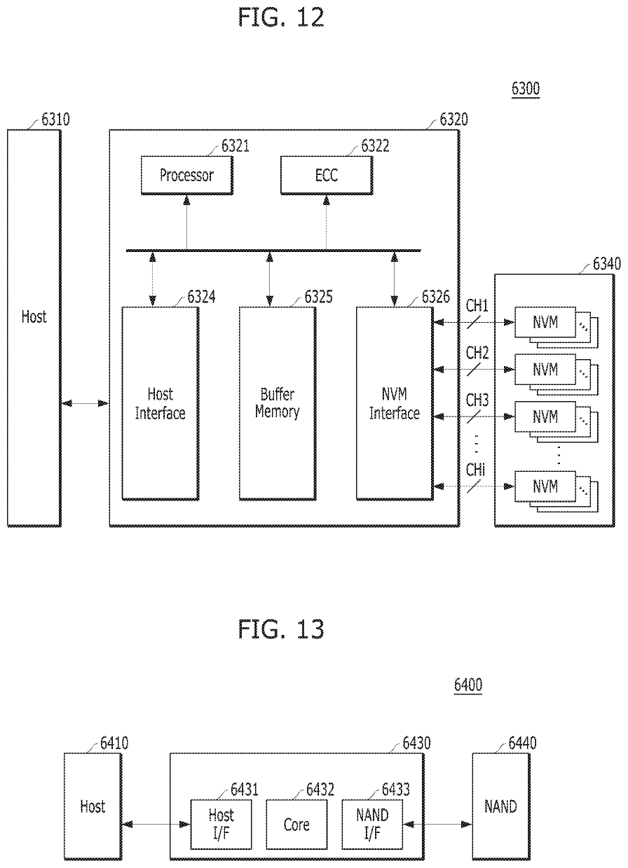

FIG. 12 is a diagram schematically illustrating another example of the data processing system including the memory system in accordance with an embodiment. FIG. 12 schematically illustrates a solid state drive (SSD) 6300 to which the memory system may be applied.

Referring to FIG. 12, the SSD 6300 may include a controller 6320 and a memory device 6340 including a plurality of nonvolatile memories (NVMs). The controller 6320 may correspond to the controller 130 in the memory system 110 of FIG. 1, and the memory device 6340 may correspond to the memory device 150 in the memory system of FIG. 1.

More specifically, the controller 6320 may be connected to the memory device 6340 through a plurality of channels CH1 to CHi. The controller 6320 may include one or more processors 6321, an error correction code (ECC) circuit 6322, a host interface 6324, a buffer memory 6325 and a memory interface, for example, a nonvolatile memory interface 6326.

The buffer memory 6325 may temporarily store data provided from the host 6310 or data provided from a plurality of flash memories NVM included in the memory device 6340, or temporarily store meta data of the plurality of flash memories NVM, for example, map data including a mapping table. The buffer memory 6325 may be embodied by any of various volatile memories such as a dynamic random access memory (DRAM), a synchronous DRAM (SDRAM), a double data rate (DDR) SDRAM, a low power DDR (LPDDR) SDRAM and a graphics RAM (GRAM) or nonvolatile memories such as a ferroelectric RAM (FRAM), a resistive RAM (RRAM or ReRAM), a spin-transfer torque magnetic RAM (STT-MRAM) and a phase-change RAM (PRAM). As an example, FIG. 12 illustrates that the buffer memory 6325 is disposed in the controller 6320, but the buffer memory 6325 may be external to the controller 6320.

The ECC circuit 6322 may calculate an error correction code (ECC) value of data to be programmed to the memory device 6340 during a program operation, perform an error correction operation on data read from the memory device 6340 based on the ECC value during a read operation, and perform an error correction operation on data recovered from the memory device 6340 during a failed data recovery operation.

The host interface 6324 may provide an interface function with an external device, for example, the host 6310, and the nonvolatile memory interface 6326 may provide an interface function with the memory device 6340 connected through the plurality of channels.

Furthermore, a plurality of SSDs 6300 to which the memory system 110 of FIG. 1 is applied may be provided to embody a data processing system, for example, a redundant array of independent disks (RAID) system. The RAID system may include the plurality of SSDs 6300 and a RAID controller for controlling the plurality of SSDs 6300. When the RAID controller performs a program operation in response to a write command provided from the host 6310, the RAID controller may select one or more memory systems or SSDs 6300 according to a plurality of RAID levels, i.e., RAID level information of the write command provided from the host 6310 in the SSDs 6300, and may output data corresponding to the write command to the selected SSDs 6300. Furthermore, when the RAID controller performs a read command in response to a read command provided from the host 6310, the RAID controller may select one or more memory systems or SSDs 6300 according to a plurality of RAID levels, that is, RAID level information of the read command provided from the host 6310 in the SSDs 6300, and provide data read from the selected SSDs 6300 to the host 6310.

FIG. 13 is a diagram schematically illustrating another example of the data processing system including the memory system in accordance with an embodiment. FIG. 13 schematically illustrates an embedded Multi-Media Card (eMMC) 6400 to which the memory system may be applied.

Referring to FIG. 13, the eMMC 6400 may include a controller 6430 and a memory device 6440 embodied by one or more NAND flash memories. The controller 6430 may correspond to the controller 130 in the memory system 110 of FIG. 1, and the memory device 6440 may correspond to the memory device 150 in the memory system 110 of FIG. 1.

More specifically, the controller 6430 may be connected to the memory device 6440 through a plurality of channels. The controller 6430 may include one or more cores 6432, a host interface (I/F) 6431 and a memory interface, for example, a NAND interface (I/F) 6433.

The core 6432 may control the operations of the eMMC 6400, the host interface 6431 may provide an interface function between the controller 6430 and the host 6410. The NAND interface 6433 may provide an interface function between the memory device 6440 and the controller 6430. For example, the host interface 6431 may serve as a parallel interface, for example, MMC interface as described with reference to FIG. 1. Furthermore, the host interface 6431 may serve as a serial interface, for example, Ultra High Speed (UHS)-I or UHS-II interface.

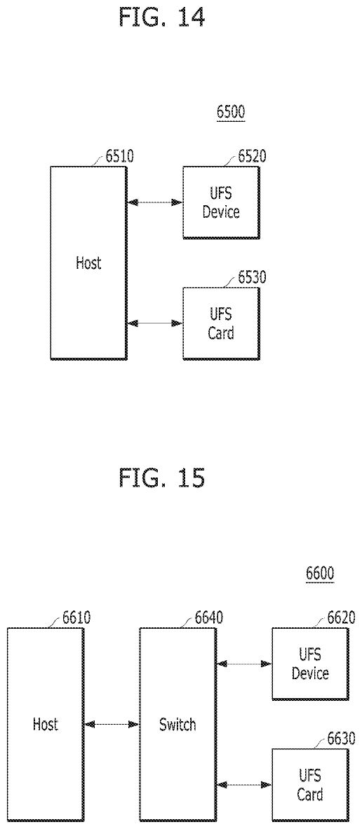

FIGS. 14 to 17 are diagrams schematically illustrating other examples of the data processing system including the memory system in accordance with embodiments. FIGS. 14 to 17 schematically illustrate universal flash storage (UFS) systems to which the memory system may be applied.

Referring to FIGS. 14 to 17, the UFS systems 6500, 6600, 6700 and 6800 may include hosts 6510, 6610, 6710, 6810, UFS devices 6520, 6620, 6720, 6820 and UFS cards 6530, 6630, 6730, 6830, respectively. The hosts 6510, 6610, 6710, 6810 may serve as application processors of wired and/or wireless electronic devices or particularly mobile electronic devices, the UFS devices 6520, 6620, 6720, 6820 may serve as embedded UFS devices. The UFS cards 6530, 6630, 6730, 6830 may serve as external embedded UFS devices or removable UFS cards.

The hosts 6510, 6610, 6710, 6810, the UFS devices 6520, 6620, 6720, 6820 and the UFS cards 6530, 6630, 6730, 6830 in the respective UFS systems 6500, 6600, 6700 and 6800 may communicate with external devices, e.g., wired and/or wireless electronic devices or particularly mobile electronic devices through UFS protocols. The UFS devices 6520, 6620, 6720, 6820 and the UFS cards 6530, 6630, 6730, 6830 may be embodied by the memory system 110 illustrated in FIG. 1. For example, in the UFS systems 6500, 6600, 6700, 6800, the UFS devices 6520, 6620, 6720, 6820 may be embodied in the form of the data processing system 6200, the SSD 6300 or the eMMC 6400 described with reference to FIGS. 11 to 13, and the UFS cards 6530, 6630, 6730, 6830 may be embodied in the form of the memory card system 6100 described with reference to FIG. 10.

Furthermore, in the UFS systems 6500, 6600, 6700 and 6800, the hosts 6510, 6610, 6710, 6810, the UFS devices 6520, 6620, 6720, 6820 and the UFS cards 6530, 6630, 6730, 6830 may communicate with each other through an UFS interface, for example, MIPI M-PHY and MIPI UniPro (Unified Protocol) in MIPI (Mobile Industry Processor Interface). Furthermore, the UFS devices 6520, 6620, 6720, 6820 and the UFS cards 6530, 6630, 6730, 6830 may communicate with each other through various protocols other than the UFS protocol, e.g., universal storage bus (USB) Flash Drives (UFDs), multi-media card (MMC), secure digital (SD), mini-SD, and micro-SD.

In the UFS system 6500 illustrated in FIG. 14, each of the host 6510, the UFS device 6520 and the UFS card 6530 may include UniPro. The host 6510 may perform a switching operation to communicate with at least one of the UFS device 6520 and the UFS card 6530. The host 6510 may communicate with the UFS device 6520 or the UFS card 6530 through link layer switching, e.g., L3 switching at the UniPro. In this case, the UFS device 6520 and the UFS card 6530 may communicate with each other through a link layer switching at the UniPro of the host 6510. FIG. 14 illustrates, as an example, the configuration in which one UFS device 6520 and one UFS card 6530 are connected to the host 6510. However, a plurality of UFS devices and UFS cards may be connected in parallel or in the form of a star to the host 6510, and a plurality of UFS cards may be connected in parallel or in the form of a star to the UFS device 6520 or connected in series or in the form of a chain to the UFS device 6520. Herein, the form of a star means an arrangement that a single device is coupled with plural other devices or cards for centralized control.

In the UFS system 6600 illustrated in FIG. 15, each of the host 6610, the UFS device 6620 and the UFS card 6630 may include UniPro, and the host 6610 may communicate with the UFS device 6620 or the UFS card 6630 through a switching module 6640 performing a switching operation, for example, through the switching module 6640 which performs link layer switching at the UniPro, for example, L3 switching.

The UFS device 6620 and the UFS card 6630 may communicate with each other through link layer switching of the switching module 6640 at UniPro. FIG. 15 illustrates as an example, the configuration in which one UFS device 6620 and one UFS card 6630 are connected to the switching module 6640. However, a plurality of UFS devices and UFS cards may be connected in parallel or in the form of a star to the switching module 6640, and a plurality of UFS cards may be connected in series or in the form of a chain to the UFS device 6620.

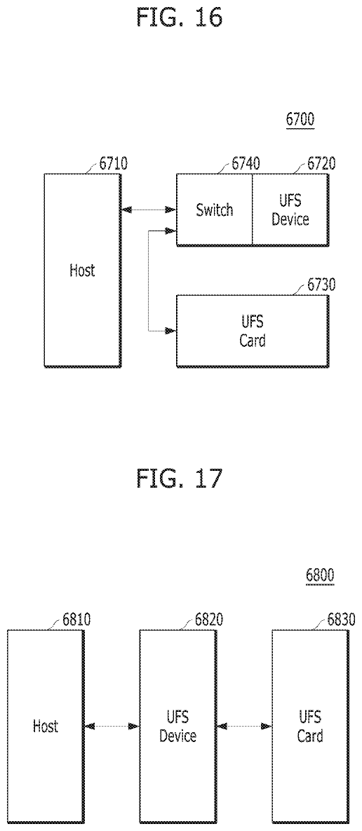

In the UFS system 6700 illustrated in FIG. 16, each of the host 6710, the UFS device 6720 and the UFS card 6730 may include UniPro. The host 6710 may communicate with the UFS device 6720 or the UFS card 6730 through a switching module 6740 performing a switching operation, for example, the switching module 6740 which performs link layer switching at the UniPro, for example, L3 switching. In this case, the UFS device 6720 and the UFS card 6730 may communicate with each other through link layer switching of the switching module 6740 at the UniPro, and the switching module 6740 may be integrated as one module with the UFS device 6720 inside or outside the UFS device 6720. FIG. 16 illustrates as an example, the configuration in which one UFS device 6720 and one UFS card 6730 are connected to the switching module 6740. However, a plurality of modules each including the switching module 6740 and the UFS device 6720 may be connected in parallel or in the form of a star to the host 6710 or connected in series or in the form of a chain to each other. Furthermore, a plurality of UFS cards may be connected in parallel or in the form of a star to the UFS device 6720.

In the UFS system 6800 illustrated in FIG. 17, each of the host 6810, the UFS device 6820 and the UFS card 6830 may include M-PHY and UniPro. The UFS device 6820 may perform a switching operation to communicate with the host 6810 and the UFS card 6830. The UFS device 6820 may communicate with the host 6810 or the UFS card 6830 through a switching operation between the M-PHY and UniPro module for communication with the host 6810 and the M-PHY and UniPro module for communication with the UFS card 6830, for example, through a target Identifier (ID) switching operation. Here, the host 6810 and the UFS card 6830 may communicate with each other through target ID switching between the M-PHY and UniPro modules of the UFS device 6820. FIG. 17 illustrates an embodiment in which one UFS device 6820 is connected to the host 6810 and one UFS card 6830 is connected to the UFS device 6820. However, a plurality of UFS devices may be connected in parallel or in the form of a star to the host 6810, or connected in series or in the form of a chain to the host 6810, and a plurality of UFS cards may be connected in parallel or in the form of a star to the UFS device 6820, or connected in series or in the form of a chain to the UFS device 6820.

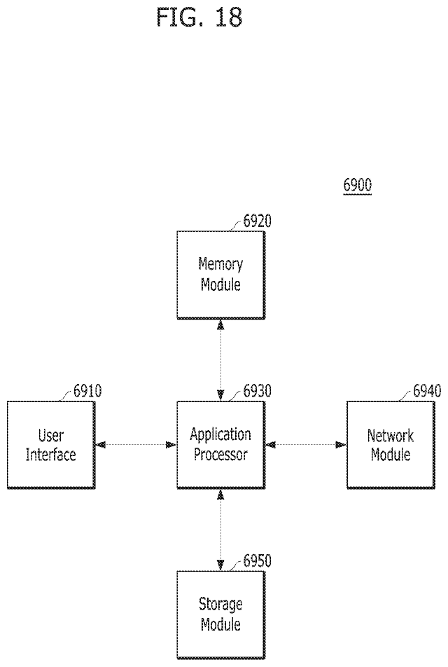

FIG. 18 is a diagram schematically illustrating another example of the data processing system including the memory system in accordance with an embodiment. FIG. 18 is a diagram schematically illustrating a user system 6900 to which the memory system may be applied.

Referring to FIG. 18, the user system 6900 may include a user interface 6910, a memory module 6920, an application processor 6930, a network module 6940, and a storage module 6950.

More specifically, the application processor 6930 may drive components included in the user system 6900, for example, an operating system (OS), and include controllers, interfaces and a graphic engine which control the components included in the user system 6900. The application processor 6930 may be provided as a System-on-Chip (SoC).

The memory module 6920 may be used as a main memory, work memory, buffer memory or cache memory of the user system 6900. The memory module 6920 may include a volatile random access memory (RAM) such as a dynamic RAM (DRAM), a synchronous DRAM (SDRAM), a double data rate (DDR) SDRAM, DDR2 SDRAM, DDR3 SDRAM, LPDDR SDARM, LPDDR3 SDRAM or LPDDR3 SDRAM or a nonvolatile RAM such as a phase-change RAM (PRAM), a resistive RAM (ReRAM), a magneto-resistive RAM (MRAM) or a ferroelectric RAM (FRAM). For example, the application processor 6930 and the memory module 6920 may be packaged and mounted, based on Package on Package (PoP).

The network module 6940 may communicate with external devices. For example, the network module 6940 may not only support wired communication, but may also support various wireless communication protocols such as code division multiple access (CDMA), global system for mobile communication (GSM), wideband CDMA (WCDMA), CDMA-2000, time division multiple access (TDMA), long term evolution (LTE), worldwide interoperability for microwave access (Wimax), wireless local area network (WLAN), ultra-wideband (UWB), Bluetooth, wireless display (WI-DI), thereby communicating with wired/wireless electronic devices, particularly mobile electronic devices. Therefore, the memory system and the data processing system can be applied to wired/wireless electronic devices. The network module 6940 may be included in the application processor 6930.

The storage module 6950 may store data, for example, data received from the application processor 6930, and then may transmit the stored data to the application processor 6930. The storage module 6950 may be embodied by a nonvolatile semiconductor memory device such as a phase-change RAM (PRAM), a magnetic RAM (MRAM), a resistive RAM (ReRAM), a NAND flash, NOR flash and 3D NAND flash, and provided as a removable storage medium such as a memory card or external drive of the user system 6900. The storage module 6950 may correspond to the memory system 110 described with reference to FIG. 1. Furthermore, the storage module 6950 may be embodied as an SSD, eMMC and UFS as described above with reference to FIGS. 12 to 17.

The user interface 6910 may include interfaces for inputting data or commands to the application processor 6930 or outputting data to an external device. For example, the user interface 6910 may include user input interfaces such as a keyboard, a keypad, a button, a touch panel, a touch screen, a touch pad, a touch ball, a camera, a microphone, a gyroscope sensor, a vibration sensor and a piezoelectric element, and user output interfaces such as a liquid crystal display (LCD), an organic light emitting diode (OLED) display device, an active matrix OLED (AMOLED) display device, an LED, a speaker and a motor.

Furthermore, when the memory system 110 of FIG. 1 is applied to a mobile electronic device of the user system 6900, the application processor 6930 may control the operations of the mobile electronic device, and the network module 6940 may serve as a communication module for controlling wired and/or wireless communication with an external device. The user interface 6910 may display data processed by the processor 6930 on a display and touch module of the mobile electronic device, or support a function of receiving data from the touch panel.

While the present invention has been illustrated and described with respect to specific embodiments, it will be apparent to those skilled in the art in light of the present disclosure that various changes and modifications may be made without departing from the spirit and scope of the invention as determined in the following claims.

What is claimed is:

1. A controller comprising:
a determination component suitable for determining whether target map data corresponding to a read request is compressible and a compression ratio for the target map data;
a memory suitable for storing a meta table in which information on whether the target map data is compressible and the compression ratio for the target map data are contained, the memory comprising a map cache buffer including a retention area and a non-retention area;
a compressor suitable for compressing the target map data at the determined compression ratio, when it is determined that the target map data is compressible; and
a processor suitable for storing the compressed target map data in the retention area.

2. The controller of claim 1, further comprising a power manager suitable for checking residual power of the controller, and providing information on the residual power to the processor.

3. The controller of claim 2, wherein the processor sets a threshold value corresponding to the residual power, and stores the target map data in the non-retention area when the compression ratio for the target map data is less than the threshold value.

4. The controller of claim 1, wherein the processor stores the target map data in the non-retention area when it is determined that the target map data is incompressible.

5. The controller of claim 1, wherein the meta table stores the information on whether the target map data is compressible and the compression ratio in bitmap form.

6. The controller of claim 1, wherein the determination component determines the information on whether the target map data is compressible and the compression ratio, when a map update operation is performed.

7. The controller of claim 1, wherein the memory further comprises a map update buffer suitable for temporarily storing map data to be updated.

8. The controller of claim 1, wherein the memory further comprises an address buffer suitable for storing map data.

9. The controller of claim 8, wherein the memory further comprises a mapping table suitable for writing information on the map data.

10. The controller of claim 1, wherein the compression ratio comprises one of ½, ¼ and ⅛.

11. An operation method of a controller, comprising:
determining information on whether target map data corresponding to a read request is compressible and a compression ratio for the target map data;
storing the information on whether the target map data is compressible and the compression ratio;
compressing the target map data at the compression ratio, when it is determined that the target map data is compressible; and
storing the compressed target map data in a retention area of a memory.

12. The operation method of claim 11, further comprising checking residual power of the controller.

13. The operation method of claim 11, further comprising:
setting a threshold value corresponding to the residual power; and
storing the target map data in a non-retention area when it is determined that the compression ratio of the target map data is less than the threshold value.

14. The operation method of claim 11, further comprising storing the target map data in the non-retention area when the target map data is incompressible.

15. The operation method of claim 11, wherein the information on whether the target map data is compressible and the compression ratio is stored in bitmap form.

16. The operation method of claim 11, wherein the determining of the information on whether the target map data is compressible and the compression ratio is performed when a map update operation is performed.

17. The operation method of claim 11, further comprising temporarily storing map data to be updated.

18. The operation method of claim 11, wherein the compression ratio comprises one of ½, ¼ and ⅛.

19. A memory system comprising:
a memory device suitable for storing target map data corresponding to a read request; and
a controller suitable for loading the target map data from the memory device, storing the target map data in a memory including a retention area and a non-retention area, based on information on whether the target map data is compressible and a compression ratio for the target map data, compressing the target map data at the compression ratio when it is determined that the target map data is compressible, and storing the compressed target map data in the retention area.

20. The memory system of claim 19, wherein, when the memory system enters a sleep mode, the controller supplies power to the retention area, and does not supply power to the non-retention area.
